(19) United States
(12) Patent Application Publication
(10) Pub. No.: US 2013/0033043 A1
(43) Pub. Date: Feb. 7, 2013

(54) WIND TURBINE GENERATOR SET

(71) Applicant: Ching Yuan HUANG, Taipei (TW)

(72) Inventor: Ching Yuan HUANG, Taipei (TW)

(21) Appl. No.: 13/195,911

(22) Filed: Aug. 2, 2011

(51) Int. Cl. F03D 9/00

(52) U.S. Cl. 290/55

(57) ABSTRACT

A wind turbine generator set includes a support framework; a generator unit; at least one rotors mounted for rotation about a horizontal axis defining a lower halve and an upper halve portions of the rotor and operatively connected to the generator unit; a plurality of blades supported in a plurality of rows along a length of each of the at least one rotors, each blade of the plurality of blades consisted of a pair of pipe lines each having an axis extending radially from the horizontal axis and having a first end for connection to the rotor and a second end supporting a sheet plate with another second end of the other pipe line; a wind collector provided in front of the rotors and consisted of a funnel-shaped device for guiding the wind onto the second ends of the plurality of blades at the upper halve portion of the rotors.

### FIELD OF THE INVENTION

The present invention relates to the filed of wind turbine generator set and particularly to wind turbine system built with low cost.

### BACKGROUND OF THE INVENTION

Nowadays, environmental consciousness has been upsurging due to both the soaring high of global oil price and climate abnormality caused by green house effect, thus green energy is becoming the hot issue to all the scientists over the world. Accordingly, this invention proposes a wind turbine system which can be readily transported and easily mounted at any desired location and are low-cost in manufacture.

### SUMMARY OF THE INVENTION

Accordingly, the present invention relates to a wind turbine generator set for utilization of kinetic energy of moving air.

In an aspect of this invention, a wind turbine generator set includes a support framework; a generator unit; at least one rotors mounted for rotation about a horizontal axis defining a lower halve and an upper halve portions of the rotor and operatively connected to the generator unit; a plurality of blades supported in a plurality of rows along a length of each of the at least one rotors, each blade of the plurality of blades consisted of a pair of pipe lines each having an axis extending radially from the horizontal axis and having a first end for connection to the rotor and a second end supporting a sheet plate with another second end of the other pipe line; a wind collector provided in front of the rotors and consisted of a funnel-shaped device for guiding the wind onto the sheet plates at the second ends of the plurality of blades at the upper halve portion of the rotors

### BRIEF DESCRIPTION OF THE DRAWINGS

FIG. 1 is a schematic side view of the wind turbine generator set according to an embodiment of this invention;

FIG. 2 is a front view of the wind turbine generator set of FIG. 1 without wind funnel; and

FIG. 3 is an illustrative view of a vessel equipped with the wind turbine generator set of FIG. 1.

### DETAILED DESCRIPTION OF THE PREFERRED EMBODIMENTS

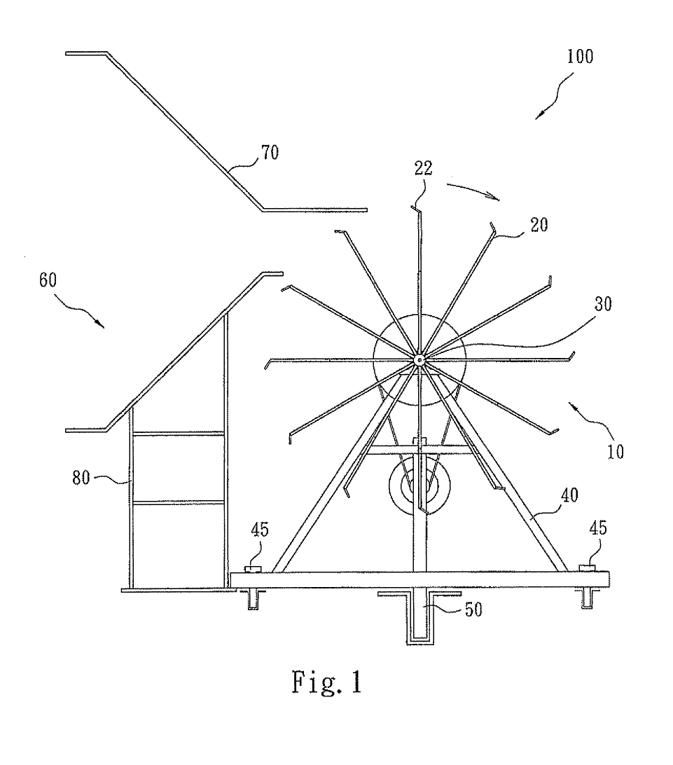

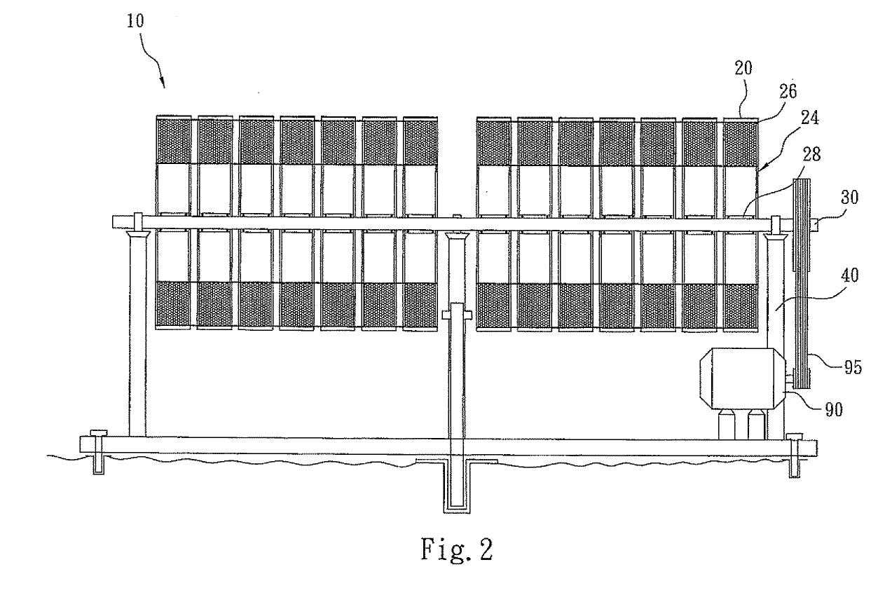

As shown in FIG. 1, a wind turbine generator set 100 according to an embodiment of the present invention is shown. The wind turbine generator set 100 comprises: a rotor 10 having twelve (12) blades 20 mounted along a length and extending radially along a horizontal axis 30 of a rotor 10; a support framework 40 for supporting the horizontal axis 30 of the rotor 10 such that the blades 20 are rotated about a central axis of the rotor 10; a central vertical shaft 50 about which the support framework 40 rotates in yaw to adjust the direction of the rotor to face the oncoming wind; a generator 90 (FIG. 2) supported on the framework 40 and operatively coupled to the rotor 10 through a driving belt 95 (FIG. 2); and a wind collector 60 provided in front of the rotor 10 for guiding the wind flow onto the engaging edges of the blades 20 such that the rotor 10 is rotated in a clockwise direction as indicated by an arrow A for power generation.

As shown in FIG. 1, the support framework 40 further comprises fixation pins 45 for fixing the framework 40 in position after the rotor 10 pivots about the central vertical shaft 50 for facing into the oncoming wind.

Each of the blades 20 defines a curved portion 22 at the free end which is preferably sharply pointed to provide better aerodynamic characteristics for the blades 20.

As shown in FIG. 1, the wind collector 60 is consisted of a funnel-shaped device 70 for collecting the wind flow in front of the rotor 10 and guiding the wind onto the second ends of the blades 20 and a frame 80 for supporting the wind collector 60 in front of the rotor 10.

FIG. 2 shows a front view of the rotors 10 in combination with a generator 90 in accordance with an embodiment of this invention without the wind collector in FIG. 1.

As shown in FIG. 2, the fourteen (14) rotors 10 are mounted in parallel along the length of the horizontal axis 30 for driving the generator 90 via the belt 95. The number of the rotors 10 may be adjusted depending upon the actual utilization.

Each of the blades 20 includes a pair of pipe lines 24 each having an axis extending radially from the horizontal axis 30 and having a first end connected to the rotor 10 with a fixation plate 28 by rivets and a second end supporting a sheet plate 26 with another second end of the other pipe line.

As the material for forming the pipe lines 24, steel, aluminum, stainless, or the like is used as long as the pipe has a strong strength to resist the wind. As the sheet plates 26, plastic, aluminum foil, or the like is used.

The operation of the present invention will now be described particularly reference to FIGS. 1 and 2. Wind traveling in a direction into the wind collector 60, the wind is guided onto the second ends of the blades 20 as shown in FIG. 1 which creates a pushing force on blades 20 and rotates the horizontal axis 30 as to drive the generator 90 as shown in FIG. 2.

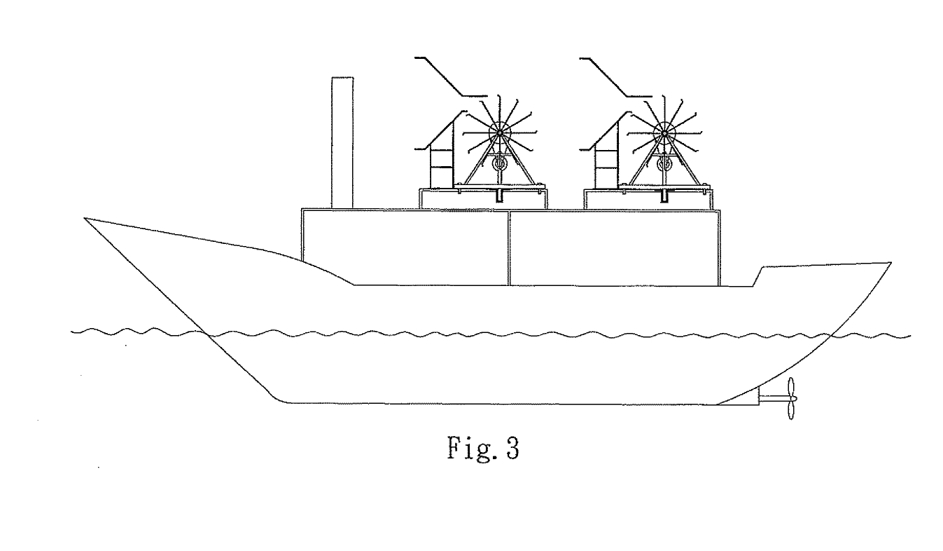

FIG. 3 is a schematic view of wind turbine generator sets embodying the invention suggesting that the invention may be utilized in on a vessel. When the wind turbine generator sets of this invention are installed on a vessel, the wind turbine generator sets may be used to generate electric power for saving the energy on the voyage or when the power of the vessel is down, the wind turbine generator set may be used as a power source for emergency use.

It is to be understood that even though numerous characteristics and advantages of the invention have been set forth in the foregoing description, together with details of the structure and function of the invention, the disclosure is illustrative only, and changes may be made in detail, especially in matter of shape, size and arrangement of parts within the principles of the invention, to the full extent indicated by the broad general meaning of the terms in which the appended claims are expressed.

What is claimed is:

1. A wind turbine generator set, comprising:
a support framework;
a generator unit;
at least one rotors mounted for rotation about a horizontal axis defining a lower halve and an upper halve portions of the rotor and operatively connected to the generator unit;
a plurality of blades supported in a plurality of rows along a length of each of the at least one rotors, each blade of the plurality of blades consisted of a pair of pipe lines each having an axis extending radially therefrom and having a first end for connection to the rotor and a second end supporting a sheet plate with another second end of the other pipe line;
a wind collector provided in front of the rotors and consisted of a funnel-shaped device for guiding the wind onto the second ends of the plurality of blades at the upper halve portion of the rotors.

2. The wind turbine generator set of claim 1 further comprising a plurality of fixation pins for fixing the support framework in place.

3. The wind turbine generator set of claim 2 further comprising: a central vertical shaft for rotationally supporting the support framework such that the rotors are rotatable thereabout.

4. The wind turbine generator set of claim 1, wherein each of the blades defines a curved portion at a free end.

5. A vessel equipped with a wind turbine generator set according to claim 1.

6. A vessel equipped with a wind turbine generator set according to claim 2.

7. A vessel equipped with a wind turbine generator set according to claim 3.

8. A vessel equipped with a wind turbine generator set according to claim 4.
